(19) United States
(12) Patent Application Publication
(10) Pub. No.: US 2025/0152451 A1
(43) Pub. Date: May 15, 2025

(54) BOTTOM GARMENT WITH EMBEDDED HARNESS

(71) Applicant: MASSACHUSETTS INSTITUTE OF TECHNOLOGY, Cambridge, MA (US)

(72) Inventors: Emily Alexis KAMIENSKI, Cambridge, MA (US); Haruhiko Harry ASADA, Cambridge, MA (US); Karen L. CHEN, Los Angeles, CA (US)

(21) Appl. No.: 18/837,046

(22) PCT Filed: May 16, 2023
(86) PCT No.: PCT/US2023/022415

§ 371 Date: Aug. 8, 2024

Related U.S. Application Data
(60) Provisional application No. 63/342,601, filed on May 16, 2022.

(51) Int. Cl. A61H 3/00

(52) U.S. Cl. CPC A61H 3/008; A61H 2201/0173; A61H 2201/1628; A61H 2201/1652; A61H 2201/5058

(57) ABSTRACT

Systems and devices are disclosed for mobility assistance of users with instability or reduced mobility when walking. The mobility device can be a garment (e.g., pants, shorts) that includes a wearable harness embedded or otherwise associated with the garment in a manner that allows the garment to be worn without the harness being outwardly noticeable. The garment can be worn in conjunction with being connected to a walker or other mobility aid vehicle, as well as in everyday use. The harness associated with the garment provides support for the user while a majority of the harness is invisible from outside the garment. A connector can be utilized in conjunction with the same to help manage the connection between the harness and the mobility aid vehicle. The connector can include the ability to mitigate or stop a fall in response to parameters detected by sensors associated with the garment or system.

### CROSS REFERENCE TO RELATED APPLICATION

The present disclosure claims priority to and the benefit of U.S. Provisional Patent Application No. 63/342,601, entitled “Pants with Embedded Harness for Daily Use” filed on May 16, 2022, the content of which is incorporated by reference herein in its entirety.

### FIELD

The present disclosure relates to systems and garments used in conjunction with medical mobility technologies, as well as methods associated with the same, and more particularly relates to clothing (e.g., pants) that have an integrated harness structure associated with it that enables easy connection to mobility aid devices (e.g., walkers) while still allowing the clothing to be comfortably worn even when not connected to the mobility aid device(s).

### BACKGROUND

Among the elderly population, aged 65 years or older, falls are far more than a minor pain or inconvenience. The effects of falling can be devastating on an individual's quality of life, with consequences ranging from disability and distress to long-term care admission, or, in extreme cases, even mortality. It is expected that the number of falls among the elderly will increase both as the prevalence of chronic disease and the age of the elderly also increases. While gait trainers exist to help individuals safely improve the quality of their range of motion, and in doing so, quality of life, such equipment is expensive and requires facilitation from trained physical therapists or other healthcare professionals. Gait training often employs the use of harnesses that are bulky and difficult to put on and take off. This makes it especially difficult for seniors to use as it impedes their ability to use the bathroom with ease. Gait training is time intensive, expensive, and thus generally impractical for a population of an imbalanced economic and social background.

In addition to the financial and time burdens that physical therapy can incur, appearance-based factors make gait training and mobility-aid devices in general less appealing. The stigmas surrounding mobility aid use are rampant among seniors. Many elderly people do not adopt assistive devices that could increase their safety because of the fear of negative social connotations of using such medical devices, such as medical support harnesses. This fear is often due to the appearance of aging and physical decline. By considering the human factors in designing dynamic mobility aids, the social barriers-to-use of mobility aids can be mitigated.

Current mobility medical devices, including canes, walkers, and crutches, increase the patient's base of support minimally. Even walkers do not guarantee that patients will not fall while using them. The current harness-based assistance devices are effective in preventing the patient from falling, but do not address the stigmas surrounding assistive mobility technology. Further, existing harnesses have other practical issues such as being hard to take on and off, and discomfort when worn for long periods of time. These harnesses, such as those used for gait training or transferring a person between a bed and a chair, also severely restrict movement, and have to be worn over other clothing, making them cumbersome, inconvenient, and impractical for whole day use.

Accordingly, improved systems, devices, (e.g., clothing, such as pants) and methods are needed for discrete stabilization of fall-risk patients. Such improvements will enable long-term, accessible solutions to seniors as to give them the necessary tools to protect themselves, especially in the comfort of their own homes.

### SUMMARY

A mobility aid of the present disclosure includes a discrete, wearable harness embedded into a pair of pants or shorts capable of being worn by a user. The harness is embedded into the pants or shorts such that a majority of the harness cannot be seen by non-users. The harness can be coupled to a mobility aid vehicle or other mobility support device through a cable connection. The mobility aid vehicle may include a connection mechanism that exerts a superior force on a user when instability or a fall is detected.

The present disclosure also provides for connectors or other attachment mechanisms that help enable safe, fast, and convenient connections to be made between the paints or shorts having the embedded wearable harness and the mobility device itself. The connectors can be used in conjunction with cables, among other techniques provided for herein or otherwise known and adaptable by those skilled in the art in view of the present disclosures.

An example garment includes an exterior side, an interior side that is opposed to the exterior side, and a harness. The exterior side is visible, and the interior side and the harness are predominantly not visible when the garment is worn in a wearing configuration. The harness is coupled to the interior side and is configured to support an entirety of body weight of a user without additional equipment coupled to the harness to provide support for the body weight of the user.

The garment can include a belt. The belt can be disposed at a top portion of the exterior side. The belt can be a top portion of the harness or coupled to the harness such that the harness extends towards a bottom portion of the garment. The belt can include an adjustable buckle that can change a size of a circumference defined by the belt. In at least some embodiments the belt can be disposed in a top portion of the garment, passing through the exterior side and passing towards and/or into the interior side. Alternatively, the belt can be passed through one or more belt loop attachments that extend from the exterior side. The loops can have a width, for example, of at least about two inches. The garment can also include one or more connection points disposed on the belt. The connection point(s) can be, for example, two connection points. In at least some such embodiments, those connection points can be disposed at opposed side of the belt.

The harness can include at least one connecting strap and at least one load-bearing strap. The connecting strap(s) can extend approximately vertically towards a bottom portion of the garment. The load-bearing strap(s) can be positioned at an angle with respect to each connecting strap of the at least one connecting strap. The load-bearing strap(s) can be configured to support an entirety of body weight of a user without additional equipment coupled to the harness to provide support for the body weight of the user. In some embodiments, the at least one load-bearing strap can include a first load-bearing strap and a second load-bearing strap. The first load-bearing strap can be positioned at an angle with respect to the connecting strap(s) and the second load-bearing strap can also be positioned at an angle with respect to the connecting strap(s). The angle at which the first load-bearing strap can be positioned with respect to the connecting strap(s) and the angle at which the second load-bearing strap can be positioned with respect to the connecting strap(s) can both be approximately 90 degrees.

In at least some embodiments, the connecting strap(s) can include a first connecting strap and a second connecting strap. The first connecting strap can extend approximately vertically towards a bottom portion of a first leg of the garment and the second connecting strap can extend approximately vertically towards a bottom portion of a second leg of the garment. Further, the load-bearing strap(s) can include a first load-bearing strap and a second load-bearing strap. The first load-bearing strap can be positioned at an angle with respect to the first connecting strap and disposed within the first leg, while the second load-bearing strap can be positioned at an angle with respect to the second connecting strap and disposed within the second leg. In at least some such embodiments, the load-bearing strap(s) can include a third load-bearing strap and a fourth load-bearing strap. The third load-bearing strap can be positioned at an angle with respect to the first connecting strap and disposed within the first leg, while the fourth load-bearing strap can be positioned at an angle with respect to the second connecting strap and disposed within the second leg. The angles at which the first and third load-bearing straps can be positioned with respect to the first connecting strap and the angles at which the second and fourth load-bearing straps can be positioned with respect to the second connecting strap can be approximately 90 degrees. Alternatively, the angles at which the first and third load-bearing straps can be positioned with respect to the first connecting strap and the angles at which the second and fourth load-bearing straps can be positioned with respect to the second connecting strap can be each non-orthogonal such that the first and third-load bearing straps extending from the first connecting strap and the second and fourth load-bearing straps extending from the second connecting strap can be in a substantial V-shape. In any of the embodiments that include at least one load-bearing strap, the garment can include one or more pads disposed on one or more of the load-bearing strap(s).

The garment can also include an inner sleeve. The inner sleeve can be coupled to the interior side of the garment and can be configured to receive the harness. In at least some such embodiments, the inner sleeve can include one or more channels formed in it with the harness being disposed within the channel(s). In some embodiments, the harness can be woven into at least a portion of the inner sleeve. In at least some embodiments, the garment can include pants.

The garment can include one or more sensors. The sensor(s) can be coupled to at least one of the exterior side, the interior side, the harness, and/or, when provided, the belt. The sensor(s) can be configured to detect one or more parameters associated with gait training and/or detecting at least one of a fall or instability of a user. The garment can also include a controller configured to instruct actions to be taken to mitigate or stop a fall or instability from occurring when detection of the one or more parameters leads to a determination that a fall or instability may be occurring.

Another example garment includes a thin fabric material and a harness coupled to an exterior side of the thin fabric material. The harness includes at least one connecting strap and at least one load-bearing strap. The at least one connecting strap extends approximately vertically towards a bottom portion of the garment. The at least one load-bearing strap is positioned at an angle with respect to each connecting strap of the at least one connecting strap. The harness is configured to support an entirety of body weight of a user without additional equipment coupled to the harness to provide support for the body weight of the user.

The load-bearing strap(s) can include a first load-bearing strap and a second load-bearing strap. Each of the first and second load-bearing straps can be positioned at an angle with respect to the connecting strap(s). In at least some such embodiments, the angle at which each of the first and second load-bearing straps is positioned with respect to the connecting strap(s) can be approximately 90 degrees.

The at least one connecting strap can include a first connecting strap and a second connecting strap. Further, the first connecting strap can extend approximately vertically towards a bottom portion of a first leg of the garment and the second connecting strap can extend approximately vertically towards a bottom portion of a second leg of the garment. The at least one load-bearing strap can likewise include a first load-bearing strap and a second load-bearing strap. Each of the first and second load-bearing straps can be positioned at an angle with respect to the respective first and second connecting straps and disposed within the respective first and second legs of the garment. In at least some such embodiments, the at least one load-bearing strap can include a third load-bearing strap and a fourth load-bearing strap. The third and fourth load-bearing straps can each be positioned at an angle with respect to the respective first and second connecting straps and disposed within the respective first and second legs. The angles at which the first and third load-bearing straps can be positioned with respect to the first connecting strap and the angles at which the second and fourth load-bearing straps can be positioned with respect to the second connecting strap can each be approximately 90 degrees. Alternatively, the angles at which the first and third load-bearing straps can be positioned with respect to the first connecting strap and the angles at which the second and fourth load-bearing straps can be positioned with respect to the second connecting strap can each be non-orthogonal such that the first and third load-bearing straps and the second and fourth load-bearing straps can extend from the respective first and second connecting straps in a substantial V-shape.

The garment can further include one or more pads disposed on one or more of the at least one load-bearing strap. Additionally, or alternatively, the garment can include a belt. The belt can be disposed at a top portion of the thin fabric material. Further, the belt can be one of a top portion of the harness or coupled to the harness such that the harness extends towards a bottom portion of the garment. In at least some such embodiments, the belt can include an adjustable buckle that can change a size of a circumference defined by the belt. The garment can further include one or more connection points disposed on the belt. The connection point(s) can be, for example, two connection points, and such connection points can be disposed at opposed sides of the belt.

In at least some embodiments, the garment can include one or more sensors. The sensors can be coupled to least one of the thin fabric material, the harness, or, when provided, the belt. The sensor(s) can be configured to detect one or more parameters associated with at least one of gait training data or detecting at least one of a fall or instability of a user. The garment can also include a controller. The controller can be configured to instruct actions be taken to mitigate or stop at least one of a fall or instability from occurring when detection of the one or more parameters leads to a determination that a fall or instability may be occurring. The garment can include shorts. In at least some such embodiments, the garment can also include pants configured to be disposed over the shorts such that the harness is predominantly not visible.

A method of gait training disclosed includes putting on a bottom garment having a harness associated with the bottom garment such that the bottom garment and the harness are put on simultaneously and wearing the bottom garment as normal wear during a portion of the day. The harness is configured for use with a mobility support device. The method also includes performing one or more gait training activities with the mobility support device while wearing the bottom garment and detaching the harness from the mobility support device while still wearing the bottom garment.

The harness can be predominantly not visible while wearing the bottom garment as normal sear during a portion of the day. The method can further include continuing to wear the bottom garment as normal wear during another portion of the day after having performed one or more gait training activities with the mobility support device while wearing the bottom garment. The bottom garment can include and/or be, for example, pants. Alternatively, the bottom garment can include and/or be, for example shorts. In some such embodiments, putting on a bottom garment having a harness configured for use with a mobility support device associated with it can include putting on a pair of pants over the shorts such that the shorts are predominantly not visible while wearing the bottom garment as normal wear during a portion of the day.

The method can further include detecting one or more parameters while performing one or more gait training activities using one or more sensors disposed on at least one of the bottom garment or the harness. The sensor(s) can be disposed on the bottom garment and/or the harness during normal wear. In at least some embodiments that includes detecting one or more parameters while performing one or more gait training activities, the method can include detecting a fall and/or instability based on the detected one or more parameters and causing a cable coupled to at least one of the bottom garment or the harness to apply tension to the bottom garment and/or harness to at least one of mitigate or stop the detected fall and/or instability.

An example connector for interfacing between a user and a mobility support device includes a housing, a spool, and a locking mechanism. The housing defines a cavity. The spool is disposed in the cavity and is rotatably coupled to the housing. The spool is configured to wrap and unwrap a cable from it. The cable is connected to each of the spool and the user. The locking mechanism is configured to selectively engage the spool to prevent rotation of the spool with respect to the housing in response to at least one of a detected instability event or a detected fall.

The connector can further include a cable guide movably coupled to the housing. The cable guide can be configured to help guide the cable as it is wrapped ad unwrapped from the spool. Additionally, or alternatively, the connector can further include an encoder. The encoder can be configured to detect one or more parameters indicative of at least one of an instability event or a fall and communicate the same in a manner that initiates the locking mechanism to selectively engage the spool to prevent rotation of the spool with respect to the housing.

### BRIEF DESCRIPTION OF DRAWINGS

This disclosure will be more fully understood from the following detailed description taken in conjunction with the accompanying drawings, in which:

FIG. 1A is a front view of an interior surface of one embodiment of a pair of pants of the present disclosure, the pants having a mobility harness associated therewith;

FIG. 1B is a front view of an exterior surface of the pants and a belt of the mobility harness of FIG. 1A;

FIG. 2 is a front, partially transparent view of the pants of FIG. 1B, the partial transparency being provided to better illustrate the mobility harness;

FIG. 3A is a front perspective view of the pants and the belt of FIG. 1B;

FIG. 3B is a side perspective view of the pants and the belt of FIG. 3A;

FIG. 4A is a front perspective view of an exterior surface of one embodiment of a pair of shorts of the present disclosure, the shorts having a mobility harness associated therewith;

FIG. 4B is a back perspective view of the shorts and the mobility harness of FIG. 4A;

FIG. 4C is a side perspective view of the shorts and the mobility harness of FIG. 4B;

FIG. 5A is a front view of the pair of shorts and the mobility harness of FIG. 4A;

FIG. 5B is front perspective view of the shorts and the mobility harness of FIG. 5A illustrated in a posture during a fall or instability event;

FIG. 6 is a side view of the shorts and the mobility harness of FIG. 5B being worn by a user in a sitting position and with the body weight of the user being supported via the mobility harness, the user wearing a pair of pants over top of the shorts;

FIG. 7A is a front perspective view of one embodiment of a connector for use with a mobility harness like those of the present disclosure and a mobility aid;

FIG. 7B is a top perspective view of the coupling mechanism of FIG. 7A;

FIG. 7C is a front perspective view of the connector of FIG. 7A coupled to a connector mount;

FIG. 7D is a side perspective view of the connector and connector mount of FIG. 7C, the connector being rotated with respect to the mount as compared to its position in FIG. 7C;

FIG. 8A is a photograph providing for a front view of a user wearing the pants of FIG. 1A, the pants being coupled to a mobility aid vehicle by way of a coupling mechanism;

FIG. 8B is a photograph providing a further front view of the user of FIG. 8A during a period of instability; and

FIG. 9 is a schematic diagram of one exemplary embodiment of a computer system upon which a control system of the present disclosure can be built.

### DETAILED DESCRIPTION

Certain exemplary embodiments will now be described to provide an overall understanding of the principles of the structure, function, manufacture, and use of the systems, devices (including clothing, which can alternatively be referred to as a garment(s)), and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Like-numbered components across embodiments generally have similar features and/or serve similar purposes unless otherwise stated or a person skilled in the art would appreciate differences based on the present disclosure and/or his/her knowledge. Accordingly, aspects and features of every embodiment may not be described with respect to each embodiment, but those aspects and features are applicable to the various embodiments unless statements or understandings are to the contrary.

The present disclosure relates to systems, devices (e.g., clothing), and methods for aiding mobility of a patient. More particularly, embodiments of clothing that can double as a mobility aid device are disclosed herein. The clothing can be worn in everyday wear while still including one or more features to enable use of the clothing with a mobility device (e.g., a walker). The clothing, typically bottoms or bottom garments such as pants and/or shorts, discretely and uniquely incorporate a harness into the bottoms in a manner that allows the patient to wear the bottoms as every day clothing while also allowing the patient to wear the clothing when using the mobility device. The clothing, at least in part via the incorporated harness, provides discrete structural support for a patient while coupled to a walker or other mobility aid vehicle or mobility support device (the terms mobility aid vehicle and mobility support device may be used interchangeably herein such that reference to one implies reference to both unless a person skilled in the art would understand such interchangeable use in a particular instance would not be possible). As discussed in detail herein, the mobility aid device can use a combination of one or more straps and one or more anchors associated with the clothing such that the straps and anchors of the harness are minimally visible from the outside of the pants. The combination of the strap(s) and anchor(s) can be referred to as a harness, and the association between the harness and the clothing can occur in a variety of ways, including but not limited to embedding the harness into the pants, weaving the harness into the pants, and/or otherwise coupling the harness to the pants or other bottoms (e.g., shorts) such that forces exerted on the patient at a location where the pants or other bottoms are being worn are received and distributed by the harness and, in at least some instances, by the pants or bottoms as well. The clothing with associated harness can be utilized with a mobility aid vehicle such as a robotic walker.

The present disclosure also provides for a connector that can assist in using the clothing in conjunction with the vehicle. The connector can receive and/or otherwise be used in conjunction with a combination of one or more cables and/or one or more spool connections such that the connector and these associated components (e.g., cable(s) and/or spool connection(s)) can couple to the clothing and the resulting system can support balance and gait training for the patient. Further, the connector can be designed to control the length of the cables supporting the patient, selectively shortening and lengthening an amount of cable to provide the necessary support for a patient during use and/or during falls and/or other instability events. An instability even can also be referred to herein as an instability. At least because the clothing is manufactured in such a manner that the associated harness is discrete and not particularly restrictive when the clothing is worn and not associated with a mobility aid vehicle, the clothing can be worn outside of the context of using a mobility aid vehicle. Accordingly, the clothing and associated components of a system (e.g., connector, cable, spool connection, etc.) are not limited to use in a clinical setting such as a hospital, doctor office, and/or physical therapy office. Rather, the disclosed embodiments can be used outside of institutional settings, including at home and/or otherwise in the community. This allows a patient to engage quickly and easily in gait training beyond clinical visits.

As used herein, the terms “mobility aid” and “mobility aid devices” can refer to the clothing into which a harness is incorporated and/or the separate, structural device, such as a walker, that a patient uses to assist in providing mobility. A person skilled in the art, in view of the present disclosures, will be able to discern the interchangeable use of these terms. Both the clothing and devices like the walker provide “mobility aid” and both can be considered “devices.” To assist in providing a distinction between the clothing and devices like walkers, in at least some instances the devices like walkers can be described as “mobility aid vehicles.” References to “systems” herein typically refer to a combination of disclosed features, such systems including, by way of non-limiting examples: the combination of the clothing and devices like a walker; the combination of the clothing and a connector and related components (e.g., ropes) to engage the clothing with devices like a walker; and/or the combination of the clothing, a connector and related components (e.g., ropes), and devices like a walker.

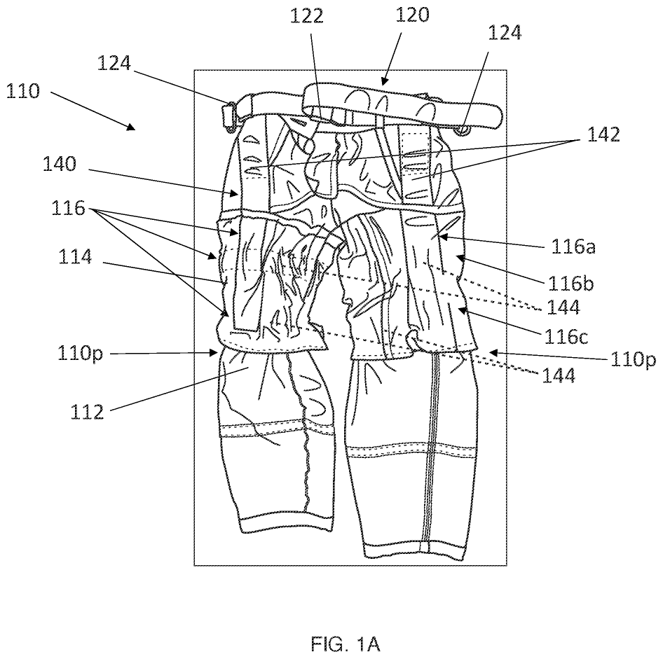

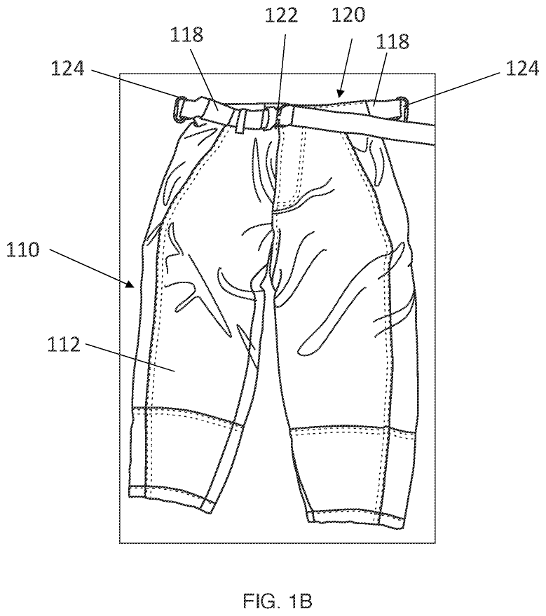

FIGS. 1A-3 illustrate one version of clothing of the present disclosure, the version of clothing being a pair of pants having a harness associated therewith. FIGS. 1A-1B provide for a first pair of pants 110, with an interior or interior side of the pants 110 being shown in FIG. 1A by virtue of the pants 110 being “inside-out,” and an exterior or exterior side of the pants 110 being shown in FIG. 1B by virtue of the pants 110 being in a “regular” or “wearing” configuration. The illustrated interior and exterior sides are opposed to each other, with the exterior being visible when the pants 110 are worn in a wearing configuration and the interior not being visible when the pants 110 are worn in the wearing configuration. Of course, even when in a “wearing” configuration, a user may roll a portion of the pants 110 in a manner that the interior side is visible, but such actions do not place that pants 110 outside of the wearing configuration. The pants 110 are considered to be in the wearing configuration if the visible portion is predominantly (at least a majority, but often more) the exterior side. Likewise, in the wearing configuration, the interior side is predominantly not visible (at least a majority, but often more). To the extent the term “predominantly” is used herein in any context, a person skilled in the art will appreciate it generally refers to at least a majority, but often more, including but not limited to at least 60%, at least about 65%, at least about 70%, at least about 75%, at least about 80%, at least about 85%, at least about 90%, at least about 95%, or other amounts appreciated by those skilled in the art.

The pants 110 have a harness 140 associated therewith. The pants 110 can include an outer sleeve or shell 112 and an inner sleeve 114, the outer sleeve 112 being the leg fabric of the pants 110, i.e., the customary portion of a pair of pants, and the inner sleeve 114 being a portion sewn into or otherwise incorporated into the pants 110 to assist in coupling or otherwise associating the harness 140 with the outer sleeve 112. For example, the inner sleeve 114 can cover, have embedded into it, and/or cushion the harness 140. As shown, the inner sleeve 114 can often not be visible when viewed in the wearing configuration (see FIG. 1B) while it can be visible when the pants 110 are viewed in the “inside-out” configuration (see FIG. 1A).

The outer sleeve or shell 112 can be the equivalent of a typical pair of pants. That is, in at least some instances, such as the instance illustrated in FIG. 1A, no modifications may be made to the outer sleeve 112 to allow it to have the inner sleeve 114 be coupled to it. Instead, the inner sleeve 114 can just be sewn into existing fabric that constitutes the outer sleeve 112 using sewn stitches, or coupled to the outer sleeve 112 using coupling techniques known to those skilled in the art. Alternatively, one or more receiving structures (e.g., one or more tabs adapted to receive a portion of the inner sleeve 114 of a component coupled to the inner sleeve 114 for using in coupling the inner sleeve 114 to the outer sleeve 112) and/or channels can be formed in the outer sleeve 112 to assist in having the inner sleeve 114 coupled thereto. The pants 110 may be any commonly available pants of any material, including but not limited to jeans, cargo, chinos, track, joggers, or sweat pants.

As shown, in at least some instances, belt loop attachments 118 can be provided at a top portion of the outer sleeve 112, extending from the exterior side of the pants 110. The belt loop attachments 118 can be wider than traditional belt loops on pants to more evenly distribute the load of a human when a belt is used in conjunction with connecting the pants 110 to a mobility aid vehicle. For example, a width of the belt loop attachments 118 can be approximately in the range of about one inch wide to about four inches wide, and in some embodiments they are at least about two inches wide. In alternative embodiments, a sleeve that is at least about 20% of a circumference of a waistband of the outer sleeve 112 can be used to receive a belt. This percentage can be at least about 30%, at least about 40% at least about 50%, at least about 60%, at least about 70% or even greater. The sleeve can be part of and/or define a waistband of the pants 110.

The inner sleeve 114 can include one or more pockets, chambers, or channels 116 (identified as individual channels 116a, 116b, and 116c on one side of the sleeve 114) formed therein for receiving the harness 140. The channels 116 can be sized and shaped to receive the harness 140. The channels 116 can be a single channel formed throughout the inner sleeve 114 where the harness 140 is to be received, or alternatively, the channels 116 can be a plurality of channels that are in communication with each other to allow portions of the harness 140 to extend between the plurality of channels through the inner sleeve 114. In the illustrated embodiment, a first vertical channel 116a can be configured to receive a connecting strap 142 while first and second horizontal channels 116b and 116c, respectively, can be configured to receive load-bearing straps 144. Although in the illustrated embodiment one side of the inner sleeve 114 identifies all channels with reference numeral 116 and an opposed side of the inner sleeve 114 identifies the channels with reference numerals 116a, 116b, 116c, both sides can include the same configuration; the different labeling is merely to that the channel 116 and the channels 116a, 116b, 116c can be referenced interchangeably.

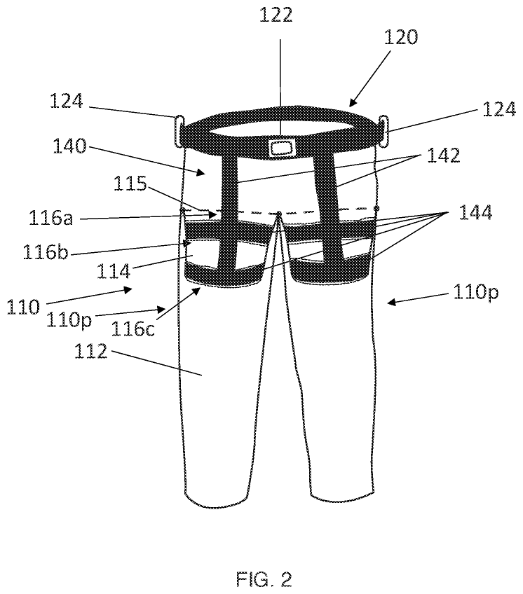

The inner sleeve 114 can be coupled to the outer sleeve 112 using any number of techniques known for attaching one portion of a garment to another portion of a garment. In the illustrated embodiment, the inner sleeve 114 is illustrated as being sewn into the outer sleeve 112. For example, in FIG. 2, a stitching line 115 is illustrated to show one non-limiting way by which the inner sleeve 114 can be coupled to the outer sleeve 112. In at least some embodiments, the inner sleeve 114 and the outer sleeve 112 can be coupled at the waist of the pants 110, for example by stitching the two together at the waist of the pants 110. In some instances, the outer sleeve 112 and the inner sleeve 114 can be made of the same material, while in other instances the outer sleeve 112 and the inner sleeve 114 can be made from different materials.

|0054| The harness 140, which is more clearly illustrated in FIG. 2, can include a connecting strap 142 on each leg of the pants 110 extending approximately vertically from or proximate to the top of the pants 110 to each of the thigh portions of the pants 110, and connecting to a set of two load-bearing straps 144 on each pant leg (reference to a pant leg is not limiting to that being a leg for pants and can also be a leg for shorts, for example). The load-bearing straps 144 are identified using dotted reference lines in FIGS. 1A and 1B because the straps are hidden from view due to being disposed in the channels 116b and 116c, although they are visible in FIG. 2 due to the transparent nature of the illustration. As shown, the load-bearing straps 144 can be positioned substantially perpendicular to the connecting strap 142 (i.e., they are disposed at approximately 90 degrees with respect to the connecting strap 142), although other configurations are possible. The load-bearing straps 144 can conform to the shape of the user's thighs by spanning the horizontal circumference of each pant leg of the outer sleeve 112 and may include an elastic portion (not shown) to improve comfort and ease of use. The elastic portion may be incorporated as part of the load-bearing straps 144, or may be a separate component of the harness 140. The elastic portion of each load-bearing strap 144 can help grip the leg of the user and ensure the load-bearing straps 144 and the inner sleeve 114 stay in a desired position with respect to the legs of the user. Other configurations for the connecting strap 142 and/or the load-bearing straps 144 are also possible. For example, in some instances, the load-bearing straps can be provided in a trellis pattern or structure to assist in distributing stress over the waist, hips, and thighs. A person skilled in the art will appreciate that the connecting straps 142 and/or the load-bearing straps 144 can be sized for different users based on the various characteristics of the user (height, weight, age, etc.) and/or can include various adjustable aspects, such as sliding features known to those skilled in the art for lengthening, tightening, or otherwise adjusting straps.

In the illustrated embodiment, the harness 140 is coupled to the outer sleeve 112 by virtue of being disposed in the inner sleeve 114 and the inner sleeve 114 being coupled to the outer sleeve 112. In an alternative embodiment, the inner sleeve 114 may not include one or more channels disposed therein, but instead can provide a surface that allows one or more channels or chambers to be formed between the outer sleeve 112 and the inner sleeve 114 such that that harness 140 is disposed therebetween. For example, the load-bearing straps 144 can be coupled to the inner surface of the pants 110 (i.e., by sewing) such that the load-bearing straps 144 are located between the inner sleeve 114 and the outer sleeve 112 during use. The coupling may be done with materials such as nylon that have a high dimensional stability. The various components of the harness 140 may be coupled together with coupling techniques such as sewing, weaving or interlocking, tying, buckling, or other methods appreciated by one skilled in the art. Likewise, the harness 140 can be coupled to one or more of the inner sleeve 114, and the outer sleeve 112 using similar techniques, although in at least some instances merely disposing the harness 140 in channels 116 can be sufficient to couple the harness 140 to the pants 110. The harness 140 can be coupled to an interior side of the pants 110. This can include the harness 140 being adjacent to and/or in contact with the interior side of the pants 110 and/or disposed within in an interior side of the pants. Similar to the interior side, the harness 140 is predominantly not visible when the pants 110 are worn in the wearing configuration.

The harness 140 can generally be designed, constructed, or otherwise configured to meet the strength requirement of supporting at least the weight of the user. One or more high-strength fabrics can be used to fabricate the harness, and fabrication can include, in at least some instances, weaving the harness 140 into the pants 110 so that a load is borne in specific directions while remaining flexible in other directions such that the weight of the user can be borne with the high-strength fabrics while not restraining the movements of the user. For example, the textile used to construct the harness 140 can be the same textile as a seatbelt strap, which in at least some instances can made of one hundred percent woven polyester, and can be designed to have a high tensile strength. The textile can bear a load approximately in the range of about 1360 kilograms to about 2722 kilograms. The harness 140 with this seatbelt textile can be woven directly into the fabric on the interior side of the pants 110. In at least some instances, the textile forming the harness 140 can be further reinforced by doubling the layer to increase further the durability and strength of the harness 140. A person skilled in the art, in view of the present disclosures, will appreciate that the stitch pattern of each connection point in the harness 140, and where the harness 140 is mated to one or more of the inner and/or outer sleeves 114, 112, can be designed to provide further robustness. In at least some instances, the stitching can be done with nylon, which can provide high dimensional stability, and/or can be done with straight stiches along the principal fabric axes of the woven polyester at least because it can be the strongest and stiffest in the principal axes.

By incorporating the harness 140 into the pants 110, and in particular into the

interior portion of the pants 110 via the inner sleeve 114, the harness 140 is largely or wholly hidden from view when viewed by others seeing only the exterior portion of the pants 110 when the pants 110 are being worn, evidenced by FIG. 1B. To the extent it is visible, it is typically by way of a belt (e.g., belt 120 described below), which is a typical accessory worn with pants anyways. Accordingly, a user can be less concerned about others knowing that the harness 140 is there and/or being used by the wearer of the pants 110. Further, by embedding the harness 140 with respect to the pants 110, no additional garments need to be put on or taken off beyond the pants 110. Still further, at least by allowing the harness 140 to have different straps 144 for each leg, use of the harness 140 as part of the pants 110 can have little to no impact on the ability of the wearer to use a toilet.

Despite its discrete placement, the harness 140 is strong enough to support an entirety of body weight of a user without using additional equipment, components, or the like coupled to or otherwise engaged with the harness to provide support. Accordingly, the pants 110 with the harness 140 incorporated therewith are sufficient for use with a mobility aid device and can support an entirety of body weight of a user in conjunction with operating the same. As shown, the harness 140 is generally disposed in a top half of the pants 110 such that the harness 140 does not extend to and/or past a knee portion 110p of the pants 110.

A belt 120 can be provided at a top or top portion of the pants 110, for example passing through the belt loop attachments 118. The belt 120 can be of a similar configuration as typical belts known for use with pants. It can include an adjustable buckle 122 for adapting to a waist of a user. The adjustable buckle 122 can change a size of a circumference defined by the belt 120 such that the circumference is similar in size to a size of the waist of the user. The belt 120 can be used to connect the harness 140 to the pants 110. In some instances, the belt 120 can be used in addition to connections made by way of the inner sleeve 114 to associate the harness 140 with the pants, while in other instances the belt 120 can be used in lieu of one or more connections made by way of the inner sleeve 114. In the illustrated embodiment, the connecting straps 142 extend from the belt 120. In some instances, the connecting straps 142 can be sewn or otherwise connected to the belt 120, while in other instances the belt 120 can be considered a part of the harness 140. Similar to the harness 140, and belts more generally, different configurations of belts can be used based on various user demographics, such as weight, height, age, etc.

The belt 120 can include one or more connection points, as shown two connection points 124, for coupling the belt 120, and thus the pants 110 and harness 140 associated therewith, to a mobility aid vehicle. The connection points 124 in the illustrated embodiment are D-rings suitable to be weight bearing and capable of receiving various connectors (e.g., ropes, cables, etc.) that can be used to couple a mobility aid device like the pants 110 and associated harness 140 with a mobility aid vehicle. In the illustrated embodiment, the connection points 124 are disposed on opposed sides of the pants 110, laterally on the hips of a user when the belt 120 is associated therewith, thus allowing for connections on both sides of a waist of a user. A person skilled in the art will appreciate a variety of different connectors that can be used as the connection points 124. Further, other numbers of connection points can be used, with additional connection points allowing for further distribution of load across the belt 120 and pants 110.

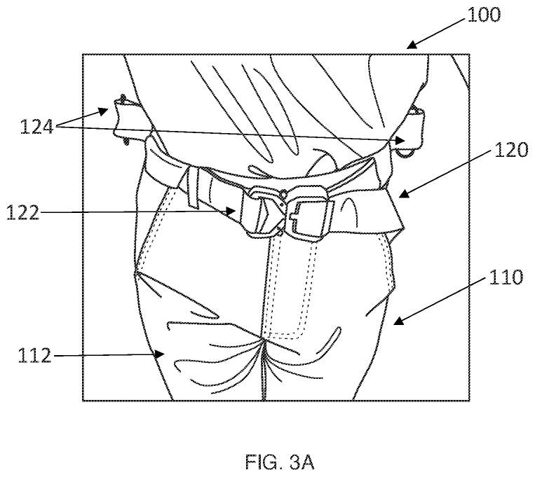

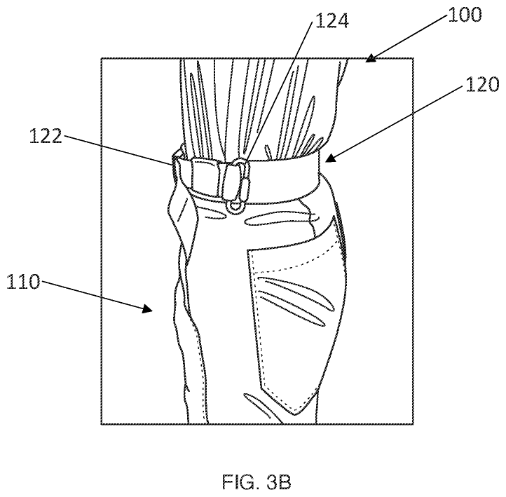

FIGS. 3A-3B illustrate the pants 110 being worn by a user 100. As shown, in use, the harness 140 is not visible but for, to the extent the belt 120 is considered part of the harness 140, the belt 120. The buckle 122 can be used to fit the belt 120 around a waist of the user and the connection points 124 can be accessible for connection to a mobility aid vehicle. The outer sleeve 112 looks of the pants 110 looks akin to a regular pair of pants with there being no indication that the harness 140 and/or the inner sleeve 114 are associated therewith.

In use, if a superior force is exerted on the harness 140 through the connection points 124, the belt 120 and the connecting straps 142 can translate the superior force to the load-bearing straps 144, causing the user to be pulled upright from the thighs and waist. The integration of the harness 140 with the pair of pants 110 offers significant ease and comfort to the user in putting on or taking off the harness 140, as the embodiments of the present disclosure allow for smooth coupling of the pants 110 and harness 140 for day-long wear.

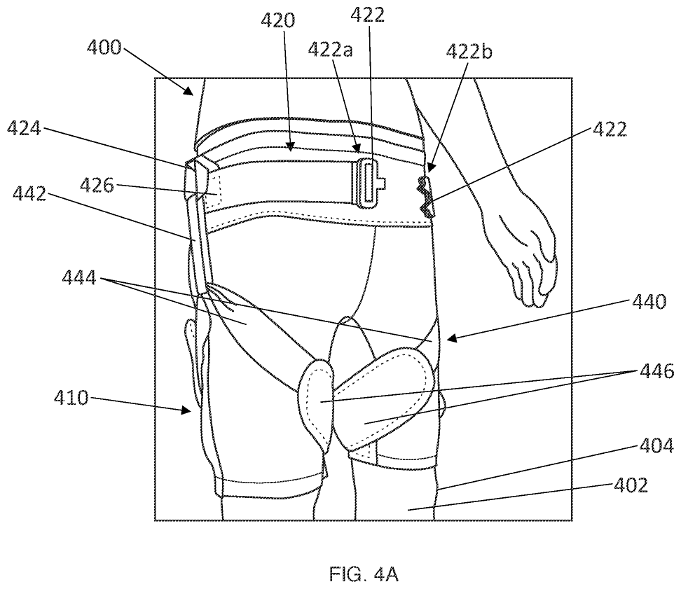

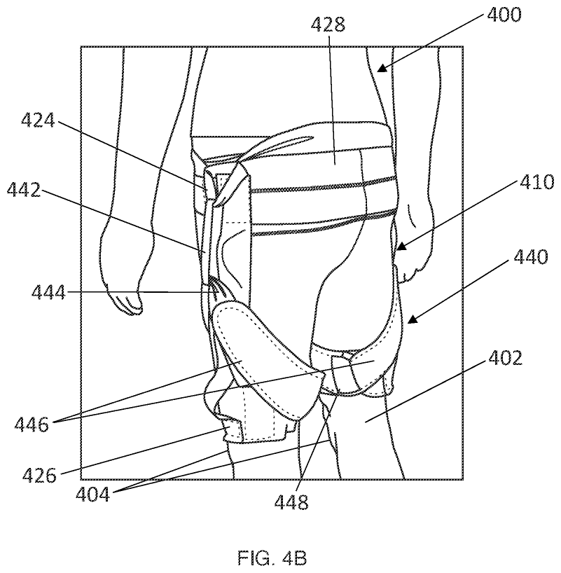

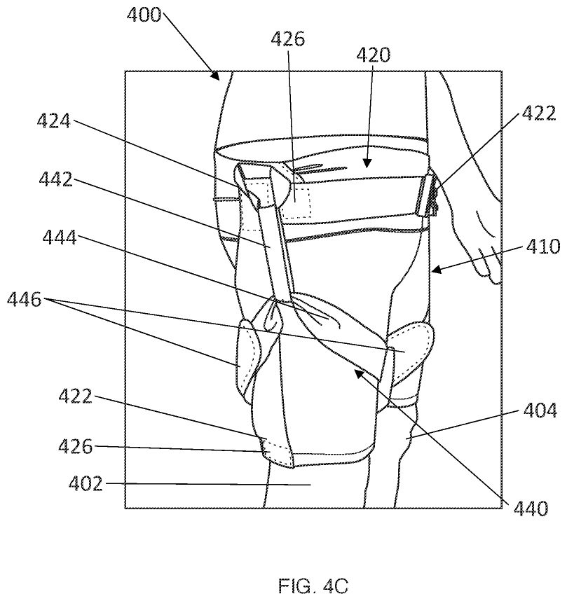

FIGS. 4A-4C illustrate another version of clothing of the present disclosure, the version of clothing being a pair of shorts having a harness associated therewith. These shorts 410 can be in lieu of an inner sleeve (e.g., the inner sleeve 114) as described above such that the shorts 410 can be worn underneath a typical pair of pants. As a result, all of the components of a harness 440 can be associated with the shorts 410, allowing the harness 440 to be hidden from view when the pants are being worn in a typical fashion.

The shorts 410 can be made of any material used in conjunction with shorts, although it can be advantageous for the material to be thin so that it does not added unnecessary bulk when worn underneath a typical pair of pants. Accordingly, in at least some instances, the shorts 410 can be made of spandex (sometimes referred to as Lycra or elastane) or other suitably thin material, fabric, or fabric material. In the illustrated embodiment, an associated harness 440 is wrapped around the shorts 410 and held at a location with respect to the shorts 410 by way of a belt 420 and/or by being tightened to sit close to the shorts 410 with compressive support being provided by a leg 402 of a user 400. Accordingly, the shorts 410 themselves do not have pockets, chambers, or channels formed therein like the channels 116 of the inner sleeve 114. However, in other embodiment, such features can be incorporated as part of the shorts 410, and/or features such as tabs, loops, etc. can be formed on or otherwise associated with the shorts 410 to allow for mating or coupling of the harness 440 directly to the shorts 410.

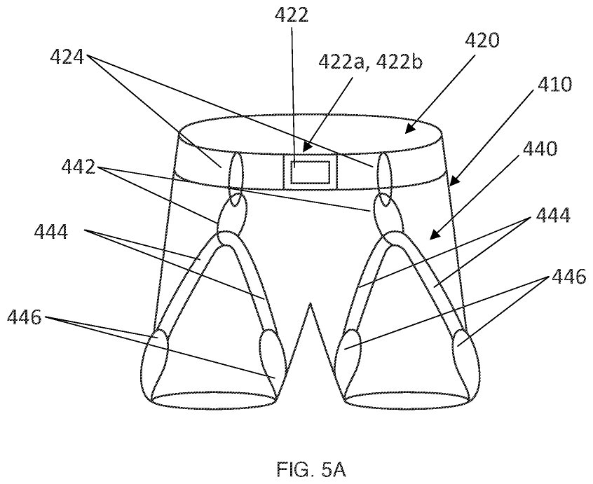

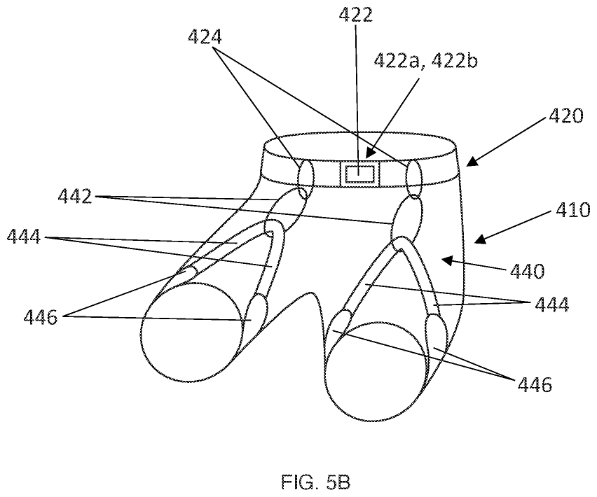

The harness 440 operates in a similar fashion as the harness 140, although the configuration is a bit different from the harness 140. As shown, the harness 440 can include a connecting strap 442 on each leg of the shorts 410 extending approximately vertically from or proximate to the top of the shorts 410 to each of the thigh portions of the shorts 410, and connecting to a set of two load-bearing straps 444 on each short leg. The load-bearing straps 444 are configured a bit differently than the straps 144 of the harness 140 at least because the load-bearing straps 444 do not sit substantially horizontally (though the straps 144 also do not have to sit horizontally and can be configured akin, or more akin, to the straps 444) with respect to the connecting strap 142. Rather, as shown, the load-bearing straps 444 extend diagonally in a substantial V-shape from the connecting strap 442, extending towards a bottom-end of the shorts 410. An angle formed between the load-bearing straps 444 and the connecting strap 442 can be non-orthogonal. In at least some embodiments, a distributing pad 446 can be disposed around at least a portion of the load-bearing straps 444. The distributing pads 446 can be wider and/or more cushioned than the load-bearing straps 444 to provide additional surface area across which load can be passed and comfort by way of cushioning. The load-bearing straps 444, either directly or by way of the distributing pads 446, can be coupled to the shorts 410 to help situate a location of the harness 440 with respect to the shorts 410. As shown in FIG. 4B, a connector 448 can be used to hold the pad 446, and thus the strap 444 disposed therein, at a bottom location of the shorts 410. A person skilled in the art will understand a variety of ways by which the harness 440 can be held in position with respect to the shorts 410. In some embodiments, each pad 446 can be coupled to the shorts 410 at or near a bottom of the shorts 410, with the pads 446 being able to help support body weight as legs are moved up (see similar configuration in FIG. 5B). As provided for herein, as the harness 440 (or other harnesses disclosed herein) support the body weight of the user, thighs of the user are pulled up slightly such that they are no longer perpendicular to a floor and supportive forces in the load-bearing strap(s) behind the leg act orthogonal to the leg. Users will typically find this level of support more comfortable than traditional harnesses, such as if the legs were kept straight. When the legs are kept straight, all forces holding the user up are frictional forces, tangent to the skin. In the illustrated embodiment, the pads 446 extend from one side of a back of a leg, around the back of the leg, and to an opposite side of the same back of the leg such that there is only one pad 446 per leg. In other embodiments, more than one pad can be used to extend around the back of a leg and/or the pad(s) 446 may not extend fully around the back of leg. The connecting strap 442 and/or the load-bearing straps 444 can have lengths that are fixed or adjustable. As shown, the shorts 410 and harness 440 are both generally disposed above a knee 404 of the user 400.

A belt 420 can be provided at a top or top portion of the shorts 410. As shown, the belt 420 is coupled to the shorts 410, for example being coupled at one or more connection locations 426. The connection locations 426 can provide connection using many techniques known to those skilled in the art, including but not limited to sewing one component to another, employing a hook-and-loop fastener (e.g., a Velcro® fastener), utilizing an adhesive, etc. The belt 420 can extend around the circumference of a waistband of the shorts 410, although as shown in FIG. 4A, it does not have to in all configurations. As shown in FIG. 4B, the belt 420 can also extend down the side of the shorts 410 to a bottom portion, being sewn together at another connection location 426. FIG. 4B also shows a reflective piece of fabric 428 disposed over at least a portion of the belt 420. The fabric 428 may or may not provide additional support for the user and/or the shorts 410. In the illustrated embodiment the fabric extends around a back side of the user 400, although in other instances the fabric 428 can be omitted. In other embodiments, the belt 420 can extend around more of a circumference of a waistband of the shorts 410, including fully around as other belts often do. At least because the shorts 410 of the illustrated embodiment are made from spandex, the belt 420 does not need to provide a function of holding up the shorts 410. Accordingly, in some embodiments, the belt 420 does not extend around a circumference of the shorts 410. The belt 420 can include an adjustable buckle 422, shown here in an unbuckled configuration with one end 422a of the buckle 422 being centrally disposed and an opposite end 422b of the buckle 422 being proximate to the left leg, around the waist, to help adjust a position of the belt 420 with respect to the shorts 410. Additional buckles 422 can also be provided, such as near the bottom of the shorts 410 as shown in FIG. 4C, providing additional points where adjustments can be made with respect to a position of the belt 420 with respect to the shorts 410.

Connection points 424 can be provided as part of the belt 420, where the connecting straps 442 couple to the belt 420. As shown, the connection points 424 can be disposed on opposed sides of the shorts 410, laterally on hips of a user when the connecting straps 442 are associated with the belt 420 and the belt 420 is being worn with the shorts 410, thus allowing for connections on both sides of a waist of a user. In the illustrated embodiment the connection points 424 are textile loops (e.g., made from a material used for the belt 420, similar to materials disclosed for the belt 120, i.e., having high tensile strength), although a person skilled in the art will appreciate a variety of different connectors and/or materials that can be used to form the connection points 424. The connection points 424 can be used to associate the connecting straps 442 to the belt 420 and distribute a superior force among the various components of the harness 440. In at least some instances, a cable clip can be attached directly to the connecting strap 442 to connect the harness 440, and thus the shorts 410, to a mobility aid vehicle. In lieu of or in addition to a cable clip. attachment can be accomplished with features including but not limited to a carabineer, D-ring, hook (i.e., clevis hook, swivel hook), or other suitable means of attachment. The clip can be attached to the end of a cable originating from a mobility aid vehicle, and can couple the connecting strap 442, and thus the harness 440, with the mobility aid vehicle. A vehicle connection point, where the clip can couple the connecting strap 442 to the mobility aid vehicle, can be at any location along the connecting strap 442.

In use, if a superior force is exerted on the harness 440, the belt 420 and connecting straps 442 can translate the superior force to the load-bearing straps 444 and/or the pads 446, causing a user 400 wearing the shorts 410 to be pulled upright from the thighs into a position that is or resembles a sitting position. As the leg pads 446 and/or load-bearing straps 444 act orthogonally to the leg, this allows the harness 440 to provide more comfortable support to leg 402. Meanwhile. the spandex or other suitable material of the shorts 410 provides smooth contact with the legs 402 and helps to further distribute forces being applied to the load-bearing straps 444 and pads 446.

FIGS. 5A-5B schematically illustrate he shorts 410 having a harness 440 associated therewith. More particularly, FIG. 5A illustrates the shorts 410 as they are worn when standing while FIG. 5B illustrates the shorts 410 in a posture consistent with how a body may be situated, and how the shorts 410 and associated components (e.g., the harness 440) may react, during a fall or other instability event. The load can be shared between the legs and the waist. The figure demonstrates how the pads 446 can help support body weight as the legs move up during a fall. As shown, one pad 446 starts on one side of one leg, extends behind the back of the leg, and to the opposed side of the leg, meaning here is only one pad 446 per leg, although other configurations are possible, including but not limited to multiple pads per leg. The belt 420 includes the adjustable buckle 422 that allows for adjustment of the waistband of shorts 410 to best fit a user. Unlike the embodiment of FIGS. 4A-4C, in this embodiment the belt 420 is fully disposed around the circumference of the waist, and thus the ends 422a, 422b of the buckle 422 are connected at a central location. The connection points 424 can be disposed on opposed sides of the waist, although as shown they do not have to be disposed at the furthest width of the waist. Instead, they can sit more centrally with respect to each leg, such as the connection points 424 sitting substantially centrally with respect to the respective leg with which it is used.

In use, if a superior force is exerted on the harness 440, the belt 420 and the connecting straps 442 can translate the superior force to the load-bearing straps 444 and/or the pads 446, causing a user to be pulled upright from the thighs into a position that is or resembles a sitting position. As the leg pads 446 and/or load-bearing straps 444 act orthogonally to the leg, this allows the harness 440 to provide more comfortable support to the leg. Meanwhile, the spandex or other suitable material of the shorts 410 provides smooth contact with the legs and helps to further distribute forces being applied to the load-bearing straps 444 and pads 446.

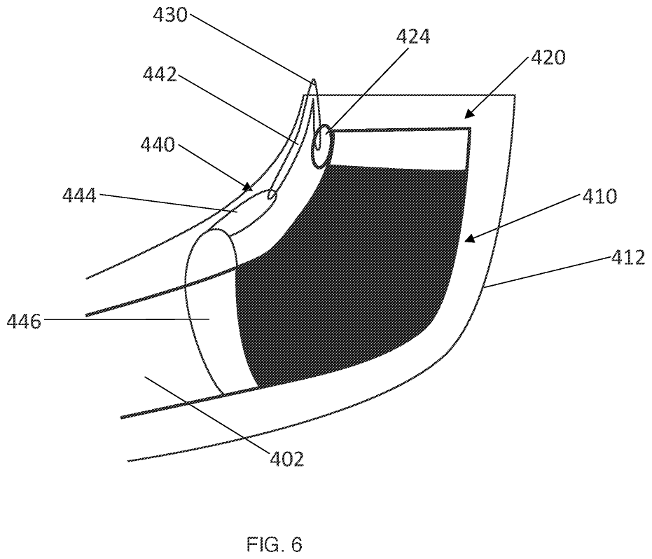

FIG. 6 illustrates the pair of shorts 410 with the harness 440 associated therewith being used in conjunction with a pair of pants, as shown an outer sleeve or shell 412. As shown, the pad 446 supports a leg 402, with the assistance of the load-bearing straps 444 and the connecting strap 442. A vehicle connection point 430 on the connecting strap 442 can be, but does not have to be, stretched outside of the shorts 410 and, optionally, outside of the outer sleeve 412 when taut to assist in helping it connect to a mobility aid vehicle. Other ways of connecting to a mobility aid vehicle, including ways provided for herein or otherwise known and/or derivable by a person skilled in the art in view of the present disclosures, can also be used to enable the use of the shorts 410 and harness 440 with a mobility aid vehicle or other mobility support device. As shown, the outer sleeve 412 can allow the shorts 410, the belt 420, and the harness 440 to be hidden from view, sitting underneath the outer sleeve 412, providing similar benefits as discussed above as it relates to a discretely located inner sleeve 114 and harness 140.

Integrated or otherwise in communication with a harness of the present disclosure (e.g., any of the harnesses 140, 440) may be at least one sensor. The sensor can be used to provide data and/or detect the occurrence of an event, among other features. In some embodiments, the sensor may be an encoder, for example, an encoder on the cable spool, which can detect changes in a user's stability by, for example, measuring angles formed by the cable(s). In some embodiments, the sensor may be an inertial measurement unit (IMU), which can measure the specific gravity and angular rate of a user to detect falls. The sensor may be capable of measuring tension in a cable to detect stability and/or a fall. The data measured by a sensor(s) used in conjunction with the clothing and/or harness integrated therewith can be used with an active fall prevention device, which can be, for example, on a mobility aid vehicle, to initiate the start of a sequence of events that mitigate or prevent a fall from occurring in response to the detected fall via the sensor(s). Further, data gathered by a sensor(s) can also be used for purposes of determining progress by a patient during gait training, such as determining how well the person is walking, the position of the body while walking, joint angles, velocities and/or accelerations, percent of body weight being supported through the cables, and/or other information or data known by those skilled in the art that can be useful in gait training.

In certain embodiments, one or more sensors may be used in combination, i.e., more than one encoder, IMU, and/or a combination of encoders, IMUs and/or other sensors. The one or more sensors may be coupled to any portion of the various embodiments described herein, including but not limited to harnesses, belts, pants, shorts, sleeves, and/or components thereof. One or more sensors can likewise be provided on a mobility aid vehicle and/or on a person wearing the various embodiments provided for herein. By way of non-limiting example, it may be beneficial to locate one or more of the sensors at an attachment point location (e.g., connection locations 426), such as a location where the harness connects to a sleeve and/or a channel disposed in the sleeve (e.g., channels 116), to provide for a more constant position of the sensor(s), which can, in turn, lead to more consistent data due, at least in part, to the sensor(s) having a consistent location. The sensors can be in communication with a controller or control system and report information regarding the stability of the user and/or other data related to use of the embodiments provided for herein to the controller.

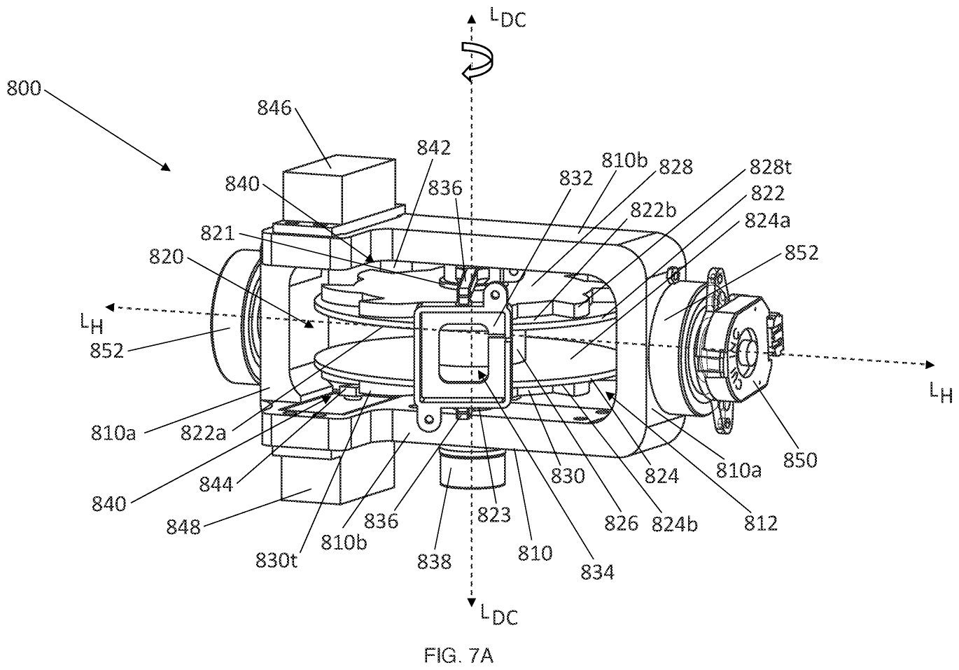

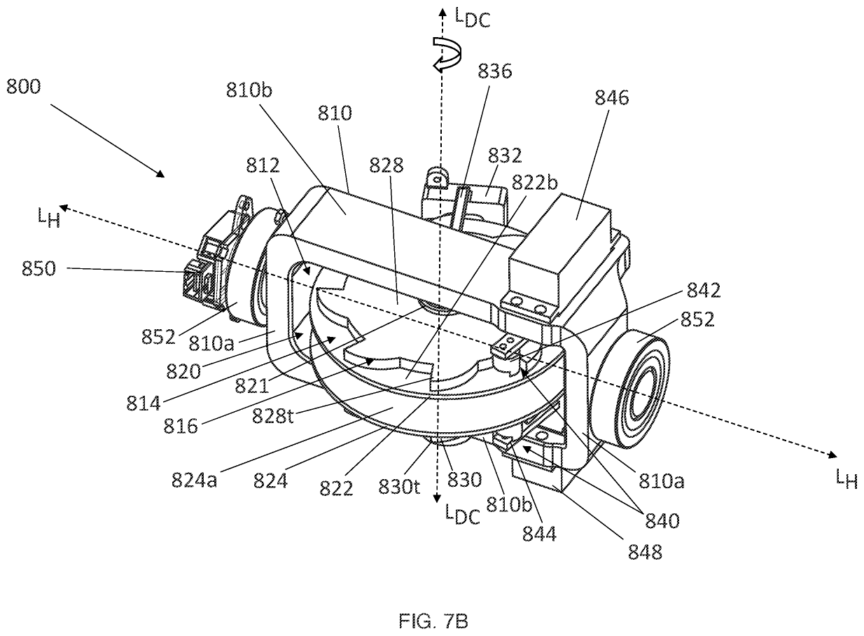

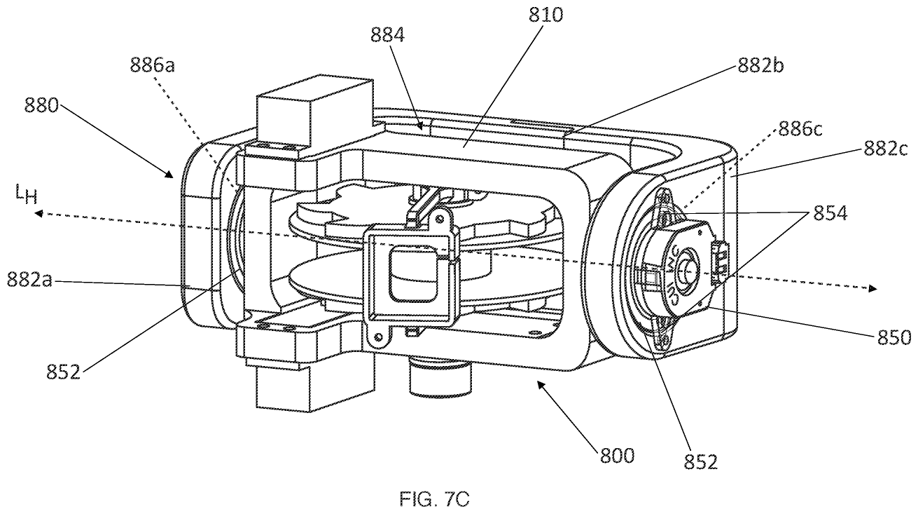

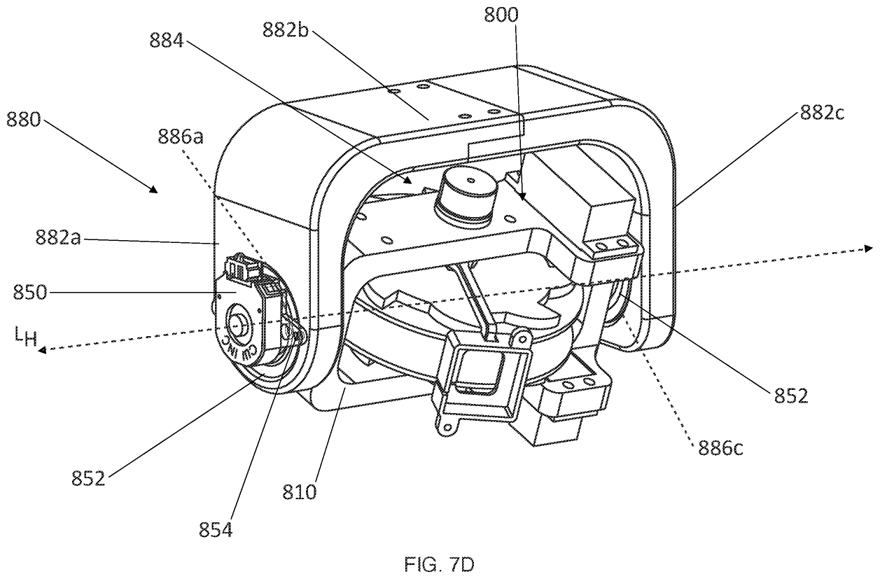

The mobility aid devices, described above as various items of clothing (e.g., pants 110, shorts 410, shorts 410 used in conjunction with an outer sleeve 412) having a harness (e.g. harness 140, harness 440) integrated or otherwise associated therewith, can be coupled to a mobility aid vehicle or mobility support device (e.g., walker or other known devices used to support a user when walking, gait training, or otherwise being standing and/or being mobile) by way of a connector. The connector helps provide for ropes, cables, or other similar type components (referred to collectively as “cables” herein for ease of reference) that can be passed from the clothing, to the connector, and then to the mobility aid vehicle, the connector helping to control parameters such as a length of the cable extending between two or more of the mobility aid vehicle, the connector, and the clothing and/or an amount of tension in the cable between any or all of the mobility aid vehicle, the connector, and the clothing. FIGS. 7A-7D depict an embodiment of one such connector, a connector 800, that can connect a harness of the present disclosure, and thus clothing with which it is integrated or otherwise associated, with a mobility aid vehicle. The connector 800 can also be referred to as a coupling mechanism or a cable actual coupling component, among other appropriate terminology.

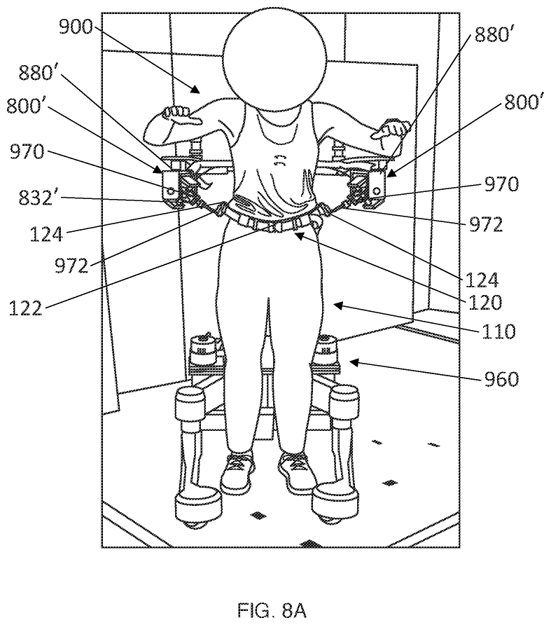

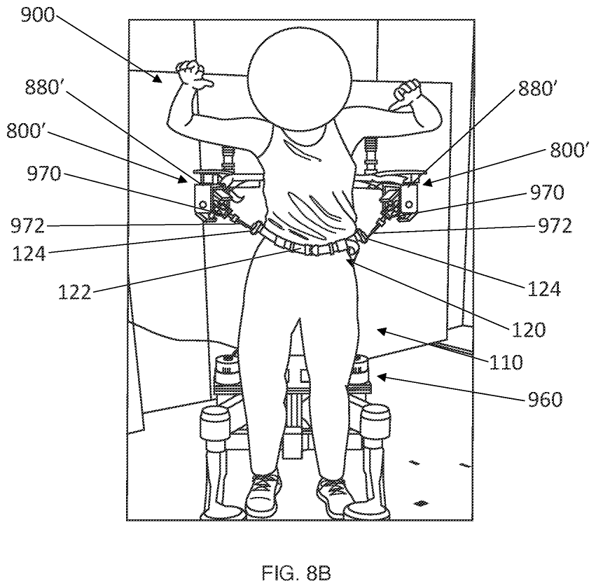

As shown, the connector 800 can include a housing 810 that provides for a base or structure to which the mechanical operating components of the connector 800 can be coupled. In the illustrated embodiment, the connector 800 is substantially a rectangular prism shape having opposed short legs or sidewalls 810a and opposed longer legs or sidewalls 810b that define the rectangular shape, with the other two sides of the prism being open. Together the sidewalls 810a, 810b define a cavity 812 that is accessible through the two open sides, the cavity 812 having various mechanical components disposed therein. In other embodiments, the open ends of the rectangular prism shape can be more closed off, including close to or fully closed off, with access to the cavity 812 being provided through one or more openings that allow one or more cables to pass into and out of the cavity 812. Although not shown in FIGS. 7A-7B, the cable can be similar to the cable provided for in FIGS. 8A-8B.

Disposed within the cavity 812 can include components such as a spool 820. The spool 820 can include a first disc-shaped flange 822 and an opposed second disc-shaped flange 824, the two flanges 822, 824 being coupled together by an intermediate, cylindrically-shaped barrel 826. The spool 820 can be rotatably connected to one or more of the sidewalls 810a, 810b. In the illustrated embodiment, the first flange 822 is coupled to one of the sidewalls 810b by way of a first mount 821 while the second flange 824 is coupled to the other of the opposed sidewalls 810b by way of a second mount 823 such that primary, flat surfaces 822a, 822b of the flanges 822, 824, respectively, are opposed to one another. The disc-shaped flanges 822, 824 are configured to rotate about a rotational axis LDc. An arrow provided for in FIG. 7A illustrates rotation about the rotational axis Lpc in a clockwise direction, but rotation in both the clockwise and counter-clockwise directions can be employed. As the spool 820 is rotated about the rotational axis LDC, a cable can be wrapped around or unwrapped from the barrel 826. The spool 820 can include an integrated power spring (not pictured) that allows a cable to be automatically retracted and wrapped around barrel 826 once tension is released. Implementation of an integrated power spring can also allow the cable to unwrap with minimal tension.

Each of the flanges 822, 824 can also include gear teeth 828t, 830t, respectively, associated therewith. More particularly, as shown, on surfaces 822b, 824b opposite to the primary, flat surfaces 822a, 824a, a toothed gear 828, 830 can be respectively disposed. Each toothed gear 828, 830 can include a plurality of teeth 828t, 830t, respectively, for engaging lock arms 842, 844 to stop rotation of the spool 820 about the rotational axis LDC, as described in greater detail below.

In at least some embodiments, a cable guide 832 can be provided to assist in managing cable as it pulled towards and/or away from the barrel 826. The cable guide 832 can include an opening 834 through which cable can pass, the guide 832 having a frame that defines the opening 834. The guide 832 can be coupled to the housing 810 in a variety of manners, the coupling typically being done in a flexible and/or rotational manner that enables the guide 832 to move with respect to the housing 810 while still effectively directing the cable towards and away from the barrel 826. In the illustrated embodiment, the guide 832 is pivotally coupled to each of the first and second mounts 821, 823 by way of guide arms 836. This configuration allows the guide 832 to move freely about the rotational axis Lpc while managing the cable as it advanced towards and away from the barrel 826.

As shown, a spool motor 838 can be provided to help drive rotation of the spool 820 about the rotational axis LDc. In the illustrated embodiment, the spool motor 838 is coupled to one of the sidewalls 810b and is configured to rotate the spool 820 to wrap and unwrap cable from the spool 820. The spool motor 838 can apply tensile forces to the cable when wrapping the cable onto the spool 820. In at least some instances, the spool motor 838 can be back drivable, attached to an approximate center axis of the spool motor (as shown the rotational axis LDC), allowing application of such tensile forces. Such tensile forces can also be applied to the person to help restore balance while walking.

Rotation of the spool 820 with respect to the rotational axis LDC can be stopped by stopping the spool motor 838. Alternatively, or additionally, one or more locking mechanisms 840 can be utilized to help set a position of the spool 820 with respect to the housing 810. As shown, two locking mechanisms 840 are provided, with a first locking arm 842 being disposed at a location where it can selectively engage teeth 828t of the first flange 822 and a second locking arm 844 being disposed at a location where it can selectively engage teeth 830t of the second flange 824. The locking arms 842, 844 can be selectively moved, such as by rotation or otherwise, into and out of the rotary path of the gears 828, 830 to selectively engage the respective teeth 828t, 830t. When the locking arms 842, 844 engage the teeth 828t, 830t, as shown in FIG. 7B, it can prevent the spool 820 from further rotating, thus setting a position and tension in the cable, stopping or preventing further unwrapping of the cable by pulling the cable taut. A person skilled in the art, in view of the present disclosures, will understand various reasons why the locking arms 842, 844 would be deployed to engage the teeth 828t, 830t, such as to set a position for the user and/or to prevent the user from falling or making ground contact by preventing the cable from further lengthening, among other reasons.

Operation of the locking mechanisms 840 for selectively deployment can be powered, for example, by one or more servomotors. In the illustrated embodiment, a first servomotor 846 is disposed on the housing 810 at a location proximate to the first locking arm 842 and a second servomotor 848 is disposed on the housing 810 at a location proximate to the second locking arm 844 so that the servomotors 846, 848 can power the respective nearby locking arms 842, 844, respectively. The servomotor or servomotors 846, 848 can be attached to the exterior sidewalls 810b of the housing 810 at an axis that is substantially parallel to the rotational axis Lpc, although other locations and configurations are possible. The servomotors 846, 848 can be engaged, for example, based on detected instability of the user, thus helping to prevent or mitigate a fall. Although in the illustrated embodiment each locking arm 842, 844 is controlled by its own servomotor 846, 848, respectively, in other embodiments a single servo motor can operate both locking arms 842, 844 and/or only one locking arm may be provided.

An encoder 850 can be associated with the housing 810. In the illustrated embodiment, the encoder 850 is coupled to one of the sidewalls 810a, positioned such that it is disposed along a longitudinal housing axis L_{H} that is substantially perpendicular to the rotational axis Lpc of the spool 820. The encoder 850 is capable of detecting a change in a motion of the user, and is thus one non-limiting example of the above-referenced sensors that can be used in conjunction with present disclosures. The encoder 850 can be in communication with the servomotors 846, 848 such that, when a change in motion is detected that is representative of a user falling, the encoder 850 can send a command to the servomotors 846, 848 to move the locking arms 842, 844 into positions that will engage the teeth 828t, 830t and prevent further movement of the spool 820 and the associated cable.

In at least some embodiments, at least one bearing 852 can be coupled to the housing 810, such as to one or more of the sidewalls 810a. One of ordinary skill in the art will appreciate that a number of different bearings, such as ball bearings or roller bearings, can be used. As shown, two ball bearings 852 are provided, one on each of the opposed sidewalls 810a, the bearings 852 being disposed centrally along the longitudinal housing axis L_{H}. The bearings 852 can assist in providing a smooth connection between the connector 800 and a mobility aid vehicle, reducing rotational friction and supporting radial and axial loads experienced by the connector 800. The bearings 852 thus allow the connector 800 to rotate along the longitudinal housing axis L_{H} while the connector 800, and thus clothing and harnesses coupled thereto, are coupled to the mobility aid vehicle and perform in response to movement by the user.

FIGS. 7C-7D illustrate the connector 800 coupled to a connector mount 880, the connector mount 880 being a structure that can be coupled to or associated with a mobility aid device or mobility support device to facilitate the positioning of the connector 800 with respect to the mobility aid device or mobility support device. The connector mount 880 can have a variety of configurations, shapes, and/or sizes, including a substantially U-shaped configuration as shown with opposed short sidewalls 882a, 882c and a longer sidewall 882b positioned between the opposed short sidewalls 882a, 882c, substantially perpendicular thereto. The three sidewalls 882a, 882b, 882c can define a cavity or opening 884 in which the connector 800 can be disposed, the connector being configured to couple to the connector mount 880. In some embodiments, such as the illustrated embodiment, the short sidewalls 882a, 882c can have a length that defines a length of the opening 884 that is sufficient to allow full rotation of the connector 800 within the opening 884 without contacting the longer sidewall 882b. In some embodiments, the length may allow less than 360 degrees of rotation of the connector 800 within the opening 884 due to contact with the longer sidewall 882b. Each short sidewall 882a, 882c can include a cutout 886a, 886c of a shape and size that is capable of receiving the bearings 852 on the housing 810 of the connector 800 within the cutout 886a, 886c. Thus, when the connector 800 is placed within the opening 884 of the connector mount 880, each bearing 852 can couple to the connector mount 880 via the respective cutout 886a, 886c by passing into the cutout 886a, 886c. The bearing 852 can be secured in this position by, for example, a locking tab 854 that extends in two directions and can contact an outward-facing side of the respective short sidewall 882a, 882b to prevent decoupling of the connector 800. A person of skill in the art will recognize, however, that a number of other coupling mechanisms may be used to secure the connector 800 in the opening 884 of the connector mount 880. The encoder 850, which is secured to the bearing 852, may pass through the cutout (i.e., the cutout 886c) of the connector mount 880 and reside on the outward-facing side of the short sidewall (i.e., the short sidewall 882c) to which the bearing 852 is coupled.

When coupled to the connector mount 880, the connector 800 can rotate about the rotational axis L_{H} in response to movement by the user and/or feedback from a sensor. This rotational movement is depicted by comparing the location of the connector 800 with respect to the mount 880 in FIGS. 7C and 7D. The connector mount 880 can be integrated into or otherwise coupled to a mobility aid vehicle. The connector mount 880 may be coupled to the mobility aid vehicle by bolting, welding, snapping, or other means of connecting the connector mount 880 to the mobility aid vehicle. The connector mount 880 can provide a stable connection between the user and the mobility aid vehicle while allowing rotation of or movement by the connector 800 as needed for gait training and/or fall/instability prevention.

FIGS. 8A-8B demonstrate a user 900 wearing the pants 110 of FIGS. 1A-3 while being connected to a mobility aid vehicle 960. Connectors 800′ are used as conduits between the pants 110 and the mobility aid vehicle 960, the connectors 800′ being disposed on opposite sides (left and right) of the mobility aid vehicle 960 and being of a similar configuration as the connector 800. The connectors 800′ are not easily visible in the two pictures, but a person skilled in the art, in view of the descriptions above related to the connector 800, will understand how the connectors 800′ operate in a similar fashion as the connector 800. The connectors 800′ are coupled to the mobility aid vehicle 960 by connector mounts 880′ that are integrated or otherwise connected to the opposite sides of the mobility aid vehicle 960. The connector mounts 880′ operate in a similar fashion to the connector mount 880.

As described above, the harness 140 (not visible) is disposed on an interior surface of the pants 110, and provides support via the connecting strap 142 (not visible) and the load-bearing straps 144 (not visible). The belt 120 can be accessible or otherwise disposed at a top of the pants 110, with the belt including the adjustable buckle 122 and opposed connection points 124 located on lateral sides of hips of the user 900. Cables 970 can be disposed through or otherwise coupled to the connection points 124. In the pictured embodiment, clips 972 are used to couple the cables 970 to the connection points 124, although in other embodiments alternative coupling mechanisms can be used in lieu of clips 972 and/or the cables 970 can be coupled directly to the connection points 124. A person of skill in the art will recognize that the clips 972 may be a trigger clip, carabineer clip, swivel hook, or other known types of clips.

The cables 970 can be coupled to a spool (not visible) in each connector 800′. The spool allows the free length of the cables 970 to adjust according to the needs of the user 900. Each connector 800′ can include cable guide 832′ that allows the respective cable 970 to extend smoothly from the spool to the belt 120, and thus to the pants 110 and harness 140. At least one sensor (i.e., an IMU, an encoder) can be coupled to one or more components of this illustrated system, e.g., the mobility aid device 960, the pants 110, the belt 120, the harness 140, the connector 800′, the cables 970 and/or other associated components to detect various parameters. This can include, for example, parameters that provide information about the stability of the user 900. As the user 900 walks, the mobility aid vehicle 960 can follow the user 900 in tandem with the gait of the user 900. The harness 140 can remain connected to the user 900 via the pants 110 and to the mobility aid vehicle 960 via the cables 970 coupled to the connector 800′.

The mobility aid vehicle 960 can include a controller (not visible), the controller being operable to enable the user to maneuver or otherwise move the mobility aid vehicle 960. The controller can be disposed on the mobility aid vehicle 960 and/or on the connectors 800′. In the illustrated embodiment, the controller is positioned on the vehicle 960 as an onboard computer, located behind the user 900, proximate to a back of the user 900. The controller, or another controller, can also be used to operate features of the pants 110, the harness 140, the belt 120, the connectors 800′, and/or associated sensors, encoders, etc. In other embodiments, the controller can be part of the garment itself. Alternatively, the extent the controller is disposed separate from the garment, such as in this illustrated embodiment, it can be operated in conjunction with the garment and a person skilled in the art will appreciate that because they can be used together, in at least some instances, the controller can be considered a part of the garment. Alternatively, the combination of a garment and a controller can be considered a system, as can any combination of a garment, a mobility aid device or mobility support device, a connector, and/or a controller.

FIG. 8B shows the user 900 during an episode of instability in which the user becomes unstable and risks a fall. As episode of instability is detected, for instance by one or more of the sensors provided for herein, one or both of the connectors 800′ can employ locking mechanisms 840′ (not easily discernable in the pictures) in a manner akin to the locking mechanisms 840 described with respect to the connector 800. As a result, the cables 970 are pulled taut, locking their positions, which in turn allows the harness 140 associated with the pants 110 to help hold up the user 900 and prevent a fall from occurring.

In an exemplary method for using the embodiments of the present disclosure, a user can dress in an embodiment of the pants 110 and/or shorts 410 provided for herein. When wearing the shorts 410, the user can wear a pair of pants, illustrated and described above as an outer sleeve 412, the pants being any type of pants desired to be worn by the user and not necessarily having any special configurations or features associated therewith. In use, the belt 120, 420, the adjustable buckle 122, 422, and/or one or more connection points 124, 424, may be visible while the harness, and/or a majority of the harness, for example in instances where the belt is considered part of the harness, is hidden from view, underneath the outer sleeve 112, 412.

At least one cable 970 can be coupled to the connection point(s) 124, 424 associated with the harness 140, 440. The cable(s) 970 can also be coupled to a mobility aid vehicle (e.g., the mobility aid vehicle 960) by way of the connector 800, 800′. As the user walks, the connector 800, 800′ can allow the cable(s) 970 to wind and unwind as necessary to provide appropriate support in conjunction with gait training and/or walking for the user. If instability or a fall is detected by one or more of the sensors (e.g., the encoder 850) provided for herein, features of the connector 800, 800′ that lock the cable(s) 970 in place can be activated. The locked cable(s) 970 can provide a superior force on the harness 140, 440 worn by the user, mitigating or altogether preventing further distal movement of the user and providing stability.

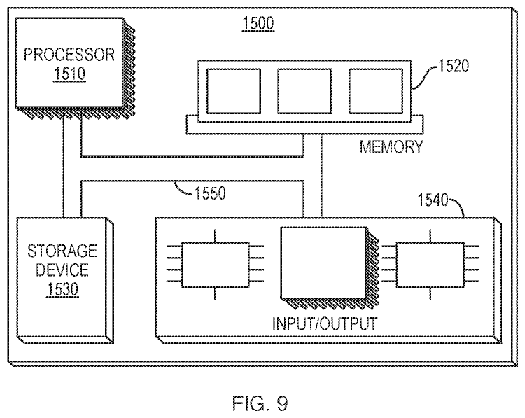

FIG. 9 is a block diagram of one exemplary embodiment of a computer system 1500 upon which the controller or control system of the present disclosures can be built, performed, trained, etc. For example, any units, stages, modules, or systems can be examples of the system 1500 described herein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500, such as instructions provided by or dictated by the various sensors (e.g., the encoder 850) described herein. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, starting and stopping the unwinding of a cable, control of a servomotor and/or a spool motor, in response to various parameters, and/or manually controlled by a user, including in response to signals/parameters/etc., and so forth, and/or based on observation/preference, and so forth, among other features described in conjunction with the present disclosure. The controller 1500 can optimize operation in response to varying inputs regarding a user's gait and/or stability. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can be, for example, a volatile memory unit or a non-volatile memory unit. In some implementations, the memory 1520 can store information related to gait, user size and weight, and so forth.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a mobility aid device. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink-wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

The garments provided for herein allow a user to wear the same clothes throughout the day as he or she wears when connected to a mobility aid vehicle or mobility support device. The wearing of garments during the day separate and apart from wearing the garments when using a mobility aid vehicle or mobility support device can be considered normal wear. A person skilled in the art will appreciate there is no set time frame that define “normal wear,” but rather, normal wear constitutes the ability for a user to wear the garments as part of daily wear, such as the user putting on the garments at a beginning of the day and wearing them around as routine clothes for the day. The incorporation of a harness into the garments allows convenience to merge with style, as the garments with which the harnesses are incorporated can look, from the outside, the same as standard garments worn by people every day. The garments of the present disclosure are convenient at least because they do not require a load-bearing harness to be put on separate from clothing when getting ready to use a mobility aid vehicle. Instead, the garment and harness are put on simultaneously because they are one and the same. This makes it easier and more efficient to get connected to the mobility aid vehicle. Further, harnesses can be cumbersome to wear, which can contribute to it being difficult to determine where each part of the harness should be disposed with respect to various body parts. A person can get easily tangled in the harness and/or may place portions of the harness in incorrect locations. By embedding or otherwise incorporating the harness into the clothing, and the user understanding how typical clothing is worn, it provides a much easier process for putting the harness at the correct locations on the body. Still further, the various embodiments disclosed herein allow for use of the harness to be discreet, which can help avoid social stigmas associated with wearing the same.

The garments provided for herein also provide smart capabilities, thus allowing for improved and safer gait training and other tasks with which the disclosed garments can be used. The integration of sensor(s) into the garment and/or components associated with the same (e.g., connectors) allow for a variety of features. For example, the sensor(s) can provide useful data to the user and/or those treating the user to better understand how a user's development, training, etc. is coming along. By way of further example, the sensor(s) can be used to help detect falls or other instability events, which can be used to trigger a response(s) to the same. Such responses can help mitigate or prevent falls and the like and/or can otherwise actively aid balance during use. Further, by incorporating sensor(s) into the garments, it can help ensure the sensor(s) are consistently placed in the same, or about the same, location during each use so that way the data generated and/or recorded can be consistent across periods of time. Overall, the garments and associated features can enable gait training and other exercises to extend outside of a clinical setting, with users wearing these garments every day in conjunction with using mobility aid vehicles and the like in their home and/or in the community.

Examples of the above-described embodiments can include the following:

1. A garment, comprising:

an exterior side visible when the garment is worn in a wearing configuration;

an interior side that is opposed to the exterior side and is predominantly not visible when the garment is worn in the wearing configuration; and

a harness coupled to the interior side such that the harness is predominantly not visible when the garment is worn in the wearing configuration, the harness being configured to support an entirety of body weight of a user without additional equipment coupled to the harness to provide support for the body weight of the user.

2. The garment of example 1, further comprising:

a belt disposed at a top portion of the exterior side, the belt being one of a top portion of the harness or coupled to the harness such that the harness extends towards a bottom portion of the garment.

3. The garment of example 2, wherein the belt comprises an adjustable buckle that changes a size of a circumference defined by the belt.
4. The garment of example 2 or 3, wherein the belt is disposed in a top portion of the garment, passing through the exterior side and passing at least one of towards or into the interior side.
5. The garment of example 2 or 3, wherein the belt is passed through one or more belt loop attachments extending from the exterior side, the loops having a width of at least about two inches.
6. The garment of any of examples 2 to 5, wherein the garment further comprises:

one or more connection points disposed on the belt.

7. The garment of example 6, wherein the one or more connection points comprises two connection points disposed at opposed sides of the belt.
8. The garment of any of examples 1 to 7, wherein the harness comprises:

at least one connecting strap extending approximately vertically towards a bottom portion of the garment; and

at least one load-bearing strap positioned at an angle with respect to each connecting strap of the at least one connecting strap, the at least one load-bearing strap being configured to support an entirety of body weight of a user without additional equipment coupled to the harness to provide support for the body weight of the user.

9. The garment of example 8, wherein the at least one load-bearing strap further comprises a first load-bearing strap positioned at an angle with respect to the at least one connecting strap and a second load-bearing strap positioned at an angle with respect to the at least one connecting strap.
10. The garment of example 9, wherein the angle at which the first load-bearing strap is positioned with respect to the at least one connecting strap and the angle at which the second load-bearing strap is positioned with respect to the at least one connecting strap are both approximately 90 degrees.
11. The garment of example 8,

wherein the at least one connecting strap comprises a first connecting strap extending approximately vertically towards a bottom portion of a first leg of the garment and a second connecting strap extending approximately vertically towards a bottom portion of a second leg of the garment, and

wherein the at least one load-bearing strap comprises a first load-bearing strap positioned at an angle with respect to the first connecting strap and disposed within the first leg and a second load-bearing strap positioned at an angle with respect to the second connecting strap and disposed within the second leg.

12. The garment of example 11, wherein the at least one load-bearing strap further comprises:

a third load-bearing strap positioned at an angle with respect to the first connecting strap and disposed within the first leg, and

a fourth load-bearing strap positioned at an angle with respect to the second connecting strap and disposed within the second leg.

13. The garment of example 12, wherein the angles at which the first load-bearing strap and the third load-bearing strap are positioned with respect to the first connecting strap and the angles at which the second load-bearing strap and the fourth load-bearing strap are positioned with respect to the second connecting strap are each approximately 90 degrees.
14. The garment of example 12, wherein the angles at which the first load-bearing strap and the third load-bearing strap are positioned with respect to the first connecting strap and the angles at which the second load-bearing strap and the fourth load-bearing strap are positioned with respect to the second connecting strap are each non-orthogonal such that the first and third load-bearing straps extending from the first connecting strap and the second and fourth load-bearing straps extending from the second connecting strap are in a substantial V-shape.
15. The garment of any of examples 8 to 14, further comprising one or more pads disposed on one or more of the at least one load-bearing strap.
16. The garment of any of examples 1 to 15, further comprising:

an inner sleeve coupled to the interior side of the garment and configured to receive the harness.

17. The garment of example 16, wherein the inner sleeve comprises one or more channels formed therein, the harness being disposed within the one or more channels.
18. The garment of example 16 or 17, wherein the harness is woven into at least a portion of the inner sleeve.
19. The garment of any of examples 1 to 18, further comprising:

one or more sensors coupled to at least one of the exterior side, the interior side, the harness, or, when provided, the belt, the one or more sensors being configured to detect one or more parameters associated with at least one of gait training data or detecting at least one of a fall or instability of a user.

20. The garment of example 19, further comprising:

a controller configured to instruct actions be taken to mitigate or stop at least one of a fall or instability from occurring when detection of the one or more parameters leads to a determination that a fall or instability may be occurring.

21. The garment of any of examples 1 to 20, wherein the garment comprises pants.
22. A garment, comprising:

a thin fabric material; and

a harness coupled to an exterior side of the thin fabric material the harness including:
at least one connecting strap extending approximately vertically towards a bottom portion of the garment; and
at least one load-bearing strap positioned at an angle with respect to each connecting strap of the at least one connecting strap,

wherein the harness is configured to support an entirety of body weight of a user without additional equipment coupled to the harness to provide support for the body weight of the user.

23. The garment of example 22, wherein the at least one load-bearing strap further comprises a first load-bearing strap positioned at an angle with respect to the at least one connecting strap and a second load-bearing strap positioned at an angle with respect to the at least one connecting strap.
24. The garment of example 23, wherein the angle at which the first load-bearing strap is positioned with respect to the at least one connecting strap and the angle at which the second load-bearing strap is positioned with respect to the at least one connecting strap are both approximately 90 degrees.
25. The garment of example 22,

wherein the at least one connecting strap comprises a first connecting strap extending approximately vertically towards a bottom portion of a first leg of the garment and a second connecting strap extending approximately vertically towards a bottom portion of a second leg of the garment, and

wherein the at least one load-bearing strap comprises a first load-bearing strap positioned at an angle with respect to the first connecting strap and disposed within the first leg and a second load-bearing strap positioned at an angle with respect to the second connecting strap and disposed within the second leg.

26. The garment of example 25, wherein the at least one load-bearing strap further comprises:

a third load-bearing strap positioned at an angle with respect to the first connecting strap and disposed within the first leg, and

a fourth load-bearing strap positioned at an angle with respect to the second connecting strap and disposed within the second leg.

27. The garment of example 26, wherein the angles at which the first load-bearing strap and the third load-bearing strap are positioned with respect to the first connecting strap and the angles at which the second load-bearing strap and the fourth load-bearing strap are positioned with respect to the second connecting strap are each approximately 90 degrees.
28. The garment of example 26, wherein the angles at which the first load-bearing strap and the third load-bearing strap are positioned with respect to the first connecting strap and the angles at which the second load-bearing strap and the fourth load-bearing strap are positioned with respect to the second connecting strap are each non-orthogonal such that the first and third load-bearing straps extending from the first connecting strap and the second and fourth load-bearing straps extending from the second connecting strap are in a substantial V-shape.
29. The garment of any of examples 22 to 28, further comprising: one or more pads disposed on one or more of the at least one load-bearing strap.
30. The garment of any of examples 22 to 29, further comprising:

a belt disposed at a top portion of the thin fabric material, the belt being one of a top portion of the harness or coupled to the harness such that the harness extends towards a bottom portion of the garment.

31. The garment of example 30, wherein the belt comprises an adjustable buckle that changes a size of a circumference defined by the belt.
32. The garment of example 30 or 31, wherein the garment further comprises:

one or more connection points disposed on the belt.

33. The garment of example 32, wherein the one or more connection points comprises two connection points disposed at opposed sides of the belt.
34. The garment of any of examples 22 to 33, further comprising:

one or more sensors coupled to at least one of the thin fabric material, the harness, or, when provided, the belt, the one or more sensors being configured to detect one or more parameters associated with at least one of gait training data or detecting at least one of a fall or instability of a user.

35. The garment of example 34, further comprising:

a controller configured to instruct actions be taken to mitigate or stop at least one of a fall or instability from occurring when detection of the one or more parameters leads to a determination that a fall or instability may be occurring.

36. The garment of any of examples 22 to 35, wherein the garment comprises shorts.
37. The garment of example 36, further comprising:

pants configured to be disposed over the shorts such that the harness is predominantly not visible.

38. A method of gait training, comprising:

putting on a bottom garment having a harness configured for use with a mobility support device associated therewith such that bottom garment and the harness are put on simultaneously;

wearing the bottom garment as normal wear during a portion of the day;

attaching the harness to a mobility support device;

performing one or more gait training activities with the mobility support device while wearing the bottom garment;

detaching the harness from the mobility support device while still wearing the bottom garment.

39. The method of gait training of example 38, wherein the harness is predominantly not visible while wearing the bottom garment as normal wear during a portion of the day.
40. The method of gait training of example 38 or 39, further comprising:

continuing to wear the bottom garment as normal wear during another portion of the day after having performed one or more gait training activities with the mobility support device while wearing the bottom garment.

41. The method of gait training of any of examples 38 to 40, wherein the bottom garment comprises pants.
42. The method of gait training of any of examples 38 to 40,

wherein the bottom garment comprises shorts, and

wherein putting on a bottom garment having a harness configured for use with a mobility support device associated therewith further comprises putting on a pair of pants over the shorts such that the shorts are predominantly not visible while wearing the bottom garment as normal wear during a portion of the day.

43. The method of gait training of any of examples 38 to 42, further comprising:

detecting one or more parameters while performing one or more gait training activities using one or more sensors disposed on at least one of the bottom garment or the harness.

44. The method of gait training of example 43, wherein the one or more sensors are disposed on at least one of the bottom garment or the harness during normal wear.
45. The method of gait training of example 43 or 44, further comprising:

detecting at least one of a fall or instability based on the detected one or more parameters; and

causing a cable coupled to at least one of the bottom garment or the harness to apply tension thereto to at least one of mitigate or stop the detected fall or instability.

46. A connector for interfacing between a user and a mobility support device, comprising:

a housing defining a cavity;

a spool disposed in the cavity and rotatably coupled to the housing, the spool being configured to wrap and unwrap a cable therefrom, the cable being connected to each of the spool and the user; and

a locking mechanism configured to selectively engage the spool to prevent rotation of the spool with respect to the housing in response to at least one of a detected instability event or a detected fall.

47. The connector of example 46, further comprising:

a cable guide movably coupled to the housing and configured to help guide the cable as it is wrapped and unwrapped from the spool.

48. The connector of example 46 or 47, further comprising:

an encoder configured to detect one or more parameters indicative of at least one of an instability event or a fall and communicate the same in a manner that initiates the locking mechanism to selectively engage the spool to prevent rotation of the spool with respect to the housing.

One skilled in the art will appreciate further features and advantages of the disclosure based on the above-described embodiments, and that changes may be made to the embodiments within the spirit and scope of the disclosure. Accordingly, the disclosure is not to be limited by what has been particularly shown and described, except as indicated by the appended claims. For example, features illustrated with respect to pants can be incorporated into shorts, and likewise, features illustrated with respect to shorts can be incorporated into pants. By way of further example, although the present disclosure primarily describes garments in the context of bottoms such as pants and shorts, a person skilled in the art will appreciate that these same disclosures can be incorporated into other types of garments or textiles such as underwear or swimwear. Any ordering of method steps described or implied above should not be construed as limiting the disclosed methods to performance of the steps in that order. Various other methods, including additional or fewer steps, are contemplated within the scope of the present disclosure.

1. A garment, comprising:
an exterior side visible when the garment is worn in a wearing configuration;
an interior side that is opposed to the exterior side and is predominantly not visible when the garment is worn in the wearing configuration; and
a harness coupled to the interior side such that the harness is predominantly not visible when the garment is worn in the wearing configuration, the harness being configured to support an entirety of body weight of a user without additional equipment coupled to the harness to provide support for the body weight of the user.

2. The garment of claim 1, further comprising:
a belt disposed at a top portion of the exterior side, the belt being one of a top portion of the harness or coupled to the harness such that the harness extends towards a bottom portion of the garment.

3. The garment of claim 2, wherein the garment further comprises:
one or more connection points disposed on the belt.

4. The garment of claim 1, wherein the harness comprises:
at least one connecting strap extending approximately vertically towards a bottom portion of the garment; and
at least one load-bearing strap positioned at an angle with respect to each connecting strap of the at least one connecting strap, the at least one load-bearing strap being configured to support an entirety of body weight of a user without additional equipment coupled to the harness to provide support for the body weight of the user.

5. The garment of claim 4, wherein the at least one load-bearing strap further comprises a first load-bearing strap positioned at an angle with respect to the at least one connecting strap and a second load-bearing strap positioned at an angle with respect to the at least one connecting strap.

6. The garment of claim 5, wherein the angle at which the first load-bearing strap is positioned with respect to the at least one connecting strap and the angle at which the second load-bearing strap is positioned with respect to the at least one connecting strap are both approximately 90 degrees.

7. The garment of claim 4,
wherein the at least one connecting strap comprises a first connecting strap extending approximately vertically towards a bottom portion of a first leg of the garment and a second connecting strap extending approximately vertically towards a bottom portion of a second leg of the garment, and
wherein the at least one load-bearing strap comprises a first load-bearing strap positioned at an angle with respect to the first connecting strap and disposed within the first leg and a second load-bearing strap positioned at an angle with respect to the second connecting strap and disposed within the second leg.

8. The garment of claim 7, wherein the at least one load-bearing strap further comprises:
a third load-bearing strap positioned at an angle with respect to the first connecting strap and disposed within the first leg, and
a fourth load-bearing strap positioned at an angle with respect to the second connecting strap and disposed within the second leg.

9. The garment of claim 8, wherein the angles at which the first load-bearing strap and the third load-bearing strap are positioned with respect to the first connecting strap and the angles at which the second load-bearing strap and the fourth load-bearing strap are positioned with respect to the second connecting strap are each approximately 90 degrees.

10. The garment of claim 1, further comprising:
an inner sleeve coupled to the interior side of the garment and configured to receive the harness.

11. The garment of claim 10, wherein the inner sleeve comprises one or more channels formed therein, the harness being disposed within the one or more channels.

12. The garment of claim 1, further comprising:
one or more sensors coupled to at least one of the exterior side, the interior side, the harness, or, when provided, the belt, the one or more sensors being configured to detect one or more parameters associated with at least one of gait training data or detecting at least one of a fall or instability of a user.

13. A garment, comprising:
a thin fabric material; and
a harness coupled to an exterior side of the thin fabric material the harness including:
at least one connecting strap extending approximately vertically towards a bottom portion of the garment; and
at least one load-bearing strap positioned at an angle with respect to each connecting strap of the at least one connecting strap,
wherein the harness is configured to support an entirety of body weight of a user without additional equipment coupled to the harness to provide support for the body weight of the user.

14. The garment of claim 13,
wherein the at least one connecting strap comprises a first connecting strap extending approximately vertically towards a bottom portion of a first leg of the garment and a second connecting strap extending approximately vertically towards a bottom portion of a second leg of the garment, and
wherein the at least one load-bearing strap comprises a first load-bearing strap positioned at an angle with respect to the first connecting strap and disposed within the first leg and a second load-bearing strap positioned at an angle with respect to the second connecting strap and disposed within the second leg.

15. The garment of claim 14, wherein the at least one load-bearing strap further comprises:
a third load-bearing strap positioned at an angle with respect to the first connecting strap and disposed within the first leg, and
a fourth load-bearing strap positioned at an angle with respect to the second connecting strap and disposed within the second leg.

16. The garment of claim 15, wherein the angles at which the first load-bearing strap and the third load-bearing strap are positioned with respect to the first connecting strap and the angles at which the second load-bearing strap and the fourth load-bearing strap are positioned with respect to the second connecting strap are each non-orthogonal such that the first and third load-bearing straps extending from the first connecting strap and the second and fourth load-bearing straps extending from the second connecting strap are in a substantial V-shape.

17. The garment of claim 13, further comprising:
one or more sensors coupled to at least one of the thin fabric material, the harness, or, when provided, the belt, the one or more sensors being configured to detect one or more parameters associated with at least one of gait training data or detecting at least one of a fall or instability of a user.

18. (canceled)

19. A connector for interfacing between a user and a mobility support device, comprising:
a housing defining a cavity;
a spool disposed in the cavity and rotatably coupled to the housing, the spool being configured to wrap and unwrap a cable therefrom, the cable being connected to each of the spool and the user; and
a locking mechanism configured to selectively engage the spool to prevent rotation of the spool with respect to the housing in response to at least one of a detected instability event or a detected fall.

20. The connector of claim 20, further comprising:
an encoder configured to detect one or more parameters indicative of at least one of an instability event or a fall and communicate the same in a manner that initiates the locking mechanism to selectively engage the spool to prevent rotation of the spool with respect to the housing.
